(19) United States
(12) Patent Application Publication
(10) Pub. No.: US 2019/0263096 A1
(43) Pub. Date: Aug. 29, 2019

(54) MULTILAYER COMPOSITE COMPONENT

(71) Applicant: Wobben Properties GmbH, Aurich (DE)

(72) Inventor: Christina BAERTL, Aurich (DE)

(21) Appl. No.: 16/348,822

(22) PCT Filed: Nov. 9, 2017
(86) PCT No.: PCT/EP2017/078815

§ 371 Date: May 9, 2019

(30) Foreign Application Priority Data
Nov. 10, 2016 (DE) 10 2016 121 554.6

(51) Int. Cl. B32B 27/08; B32B 27/32; C08L 23/06; C08L 27/18; C08L 23/16; B64C 27/473

(52) U.S. Cl. CPC B32B 27/08; B32B 27/32; C08L 23/06; F03D 1/0675; C08L 23/16; B64C 27/473; C08L 27/18

(57) ABSTRACT

A composite component comprising the following layer construction (a) a first layer consisting at least partially of polyethylene, (b) a second layer consisting at least partially of an elastomer, (c) a third layer consisting at least partially of a thermoset or a thermoplastic, wherein the first layer is arranged directly on the second layer and wherein the second layer is arranged directly on the third layer, and wherein a textile fabric with rovings is arranged between the second layer and the third layer such that some of the rovings are embedded at least in places completely in the second layer, some of the rovings are embedded at least in places completely in the third layer, and some of the rovings are embedded at least in places partially in the second layer and partially in the third layer.

### BACKGROUND

### Technical Field

The present invention relates to a composite component, to the use of a composite component of the invention, to a wind turbine for a wind power installation, and to a method for producing a composite component.

### Description of the Related Art

Rotor blades for wind power installations have been known for some considerable time and have been described in, for example, DE 10 2004 007 487 A1 and DE 10 319 246 A1. In operation they are exposed to high loads as a result of wind pressure, erosion, temperature variations, incident UV radiation, and precipitation. Especially at locations with a tropical climate, featuring sharp changes in weather effects and a high atmospheric humidity, such as in Brazil or Taiwan, for example, though also in Germany, there is a tendency for rotor blades to erode.

With blade tip velocities of up to 300 km/h, the effect of grains of sand, salt particles, insects, raindrops or other airborne particulates is abrasive. The surface of rotor blades is heavily exposed to this abrasion, particularly in the frontal edge region, and at these places the rotor surface is ablated and there is therefore a loss of aerodynamics and stability. To reduce blade tip erosion and the associated cost and effort of maintenance and repair, it is possible to limit the maximum speed of the converter, albeit to the detriment of performance. A rational approach is therefore to improve the erosion resistance of rotor blades.

At the same time, however, the rotor blades are supposed to be extremely lightweight, in order to minimize the bending loads acting on a rotor blade hub, where present, and also on the associated bearings and the tower of the wind power installation.

Rotor blades and rotor blade elements are customarily produced in a molding process, which sees fiber materials and/or core materials, especially Balsa wood, being inserted into a rotor blade element mold and treated with a curing resin to form a robust composite material. Resin employed in the production of rotor blades or rotor blade elements frequently comprises epoxy resins. These resins are highly suitable for constructing the basis of a rotor blade or rotor blade element composed of fiber material and resin.

In order to protect the rotor blades or the rotor blade elements against effects of weathering and in particular from erosion, attempts have been made to use a surface layer with a gelcoat process as described in DE 10 344 379 A1. A disadvantage in this case is that with a process of this kind it is necessary to observe a minimum processing time until the gelcoat mixture has reacted to an extent such that it can be populated with fiber material. This slows down the process of producing a rotor blade or rotor blade element, undesirably. With the gelcoat process, moreover, it is not possible to interrupt the production of a rotor blade element or rotor blade at any desired point in order to allow bonding between gelcoat surface layer and infusion resin.

Attempts have also been made to adhere surface foils onto the rotor blade or rotor blade element or to secure them by other means subsequently on the rotor blade or rotor blade element, possibly releasably. For example, polyurethane foils are adhered to rotor blades. A further possibility from the prior art, according to DE 10 2009 002 501 A1, is to produce a crosslinked composite composed of surface foil and infusion resin. This process as well is possible particularly with polyurethane foils. Polyurethane possesses high abrasion resistance. However, it is desirable for the abrasion resistance of rotor blades and rotor blade elements to be improved still further.

US 2009/0208721 A1 discloses a composite component consisting of three layers. The first layer is a thermoset layer. The second and third layers are each a thermoplastic layer. Fibers have been added to the thermoset layer and to the second (middle) thermoplastic layer.

GB 846 868 A discloses a laminate, with a filament bound into two layers of the laminate.

WO 2013/045087 A1 discloses a composite component made of thermoplastic polymer and elastomers. The thermoplastic polymer consists of a fiber-reinforced plastic.

DE 197 38 388 A1 discloses a sheetlike, textile-reinforced semifinished product with a thermoplastic matrix consisting of pore-free main layers and intermediate layers. At least one main layer consists of a reinforcing ply impregnated with thermoplastics of the same basic type or with other compatible thermoplastics, and consolidated, this ply comprising laid fiber scrims, woven fiber fabrics, knitted fiber fabrics, or unidirectional fiber reinforcement.

U.S. Pat. No. 4,412,687 A discloses a composite component wherein the polyethylene layer is bonded to the elastomer layer. There is therefore a layer of adhesive between the polyethylene layer and the elastomer layer.

The composite plastics component described in WO 2010/118860 consists of a thermosetting synthetic resin outer layer, and an elastomeric layer, and a metal and/or plastics carrier layer. The layers are joined together in a single operation with heat treatment or with irradiation with UV light. As well as other fields of application, WO 2010/118860 also describes the use of the composite plastics component in rotor blades of helicopters or wind turbines.

### BRIEF SUMMARY

Provided is a component, more particularly a rotor blade, which is distinguished by very high wear resistance and abrasion resistance, whose production requires little time and low temperatures, and which at the same time has a high longevity.

Provided is a composite component including the following layer construction:
a) a first layer consisting at least partially of polyethylene;
b) a second layer consisting at least partially of an elastomer; and
c) a third layer consisting at least partially of a thermoset or a thermoplastic,
wherein the first layer is arranged directly on the second layer and wherein the second layer is arranged directly on the third layer, and
wherein a textile fabric with rovings is arranged between the second layer and the third layer such that
   some of the rovings are embedded at least in places completely in the second layer;
   some of the rovings are embedded at least in places completely in the third layer; and
   some of the rovings are embedded at least in places partially in the second layer and partially in the third layer.

Surprisingly it has emerged that through the use, in accordance with the invention, of a textile fabric with rovings, it is possible to improve the adhesion between the second layer and the third layer. The rovings which form the textile fabric may alternate here, along the fibers, between the individual second and third layers. The roving in this arrangement is embedded at least in places completely in the second or third layer, or during the transition between the second and third layers is embedded at least in place partially in the second layer and partially in the third layer. This transition of the rovings between the second and third layers substantially improves the adhesion of the layers to one another, since the parting of the layers would require all of the fibers of the roving to be severed or to be torn away from one of the second or third layers.

Moreover, the mechanical and thermal properties of the individual second and third layers are improved as well, since the use of the textile fabric in the second and third layers results in the formation of a fiber-polymer composite which unites the positive properties of the fibers and of the matrix material.

A roving is a bundle, a strand or multifilament yarn composed of fibers (filaments) arranged in parallel. The rovings are preferably rovings made of UHMW-PE fibers, carbon fibers, glass fibers or mixtures thereof, preferably rovings made of glass fibers.

Preference is given to a composite component wherein the rovings which are embedded at least in places completely in second the layer are interspersed predominantly with the elastomer from the second layer at the places at which the rovings are embedded in the second layer.

If the rovings are interspersed predominantly with the elastomer from the second layer, i.e., the elastomer predominantly fills out the spaces between the individual fibers of the rovings, the binding of the rovings in the second layer is particularly strong.

Preference is given to a composite component wherein the rovings which are embedded at least in places completely in the third layer are interspersed predominantly with the thermoset or the thermoplastic from the third layer at the places at which the rovings are embedded in the third layer.

If the rovings are interspersed predominantly with the thermoset from the third layer, i.e., the thermoset predominantly fills out the spaces between the individual fibers of the rovings, the binding of the rovings in the third layer is particularly strong.

Preference is given to a composite component wherein the rovings which are embedded at least in places partially in the second layer and partially in the third layer are interspersed predominantly with the elastomer from the second layer or with the thermoset or the thermoplastic from the third layer at the places at which the rovings are embedded partially in the second layer and partially in the third layer.

It is preferred if the ISO 1144 and DIN 60905 Tex value of the individual filaments of the rovings is between 250 and 2500 tex. It is preferred here if the Tex value of the individual filaments of the rovings has a value of around 300, 600, 1200 or 2400 tex. In one embodiment it is preferred if the Tex value of the individual filaments of the rovings has a value of around 300, preferably a value of between 270 and 330 tex. In a second embodiment it is preferred if the Tex value of the individual filaments of the rovings has a value of around 600, preferably a value of between 540 and 660 tex. In a third embodiment it is preferred if the Tex value of the individual filaments of the rovings has a value of around 1200, preferably a value of between 1080 and 1320 tex. In a fourth embodiment it is preferred if the Tex value of the individual filaments of the rovings has a value of around 2400, preferably a value of between 2160 and 2640 tex. In one embodiment it is preferred if the Tex value of the individual filaments of the rovings has a value of greater than or equal to 250, preferably a value of greater than or equal to 540 tex, more preferably a value of greater than or equal to 1080 tex. Particular preference is given to a composite component wherein the rovings are interspersed predominantly or completely with the elastomer from the second layer or with the thermoset or the thermoplastic from the third layer.

In-house investigations have surprisingly shown that particularly at an ISO 1144 and DIN 60905 Tex value of the individual filaments of the rovings of greater than or equal to 250 tex, the process of interspersing the rovings with the elastomer of the second layer or with the thermoset or the thermoplastic from the third layer proceeds particularly effectively and the rovings therefore can be interspersed predominantly to completely with the material. At a Tex value of below 250 tex, the individual filaments are so fine that reaction mixture used for producing the thermosets or thermoplastics is unable to penetrate between the individual filaments of the rovings. This is surprising insofar as the assumption hitherto was that, particularly at low Tex values of between 250 tex, the greater capillary forces will improve the penetration of the rovings by the respective reaction mixture. It has emerged, moreover, that rovings whose individual filaments have a Tex value of below 250 tex lack the requisite (tensile) strength.

It has likewise emerged that if the Tex value of the individual filaments of the rovings is above 2500 tex, the individual filaments and/or the roving formed from the filaments become/becomes so thick that the thicknesses required on the part of the second or third layers become too high for an ideal balance to be struck between wear and abrasion resistances and the weight of the composite component.

Preference is given to a composite component wherein the textile fabric is a woven, laid-scrim, knitted or braided fabric, preferably a woven or laid-scrim fabric.

Preference is given to a composite component wherein the textile fabric protrudes beyond the first and/or second layers on the long sides of the composite component.

Preference is given to a composite component wherein the rovings are knitted together by a thread.

In accordance, the second layer is arranged directly between the first layer and the third layer, and there are no further layers between the first, second, and third layers.

In one preferred embodiment of the present invention, the polyethylene is a high molecular weight polyethylene (HMW-PE), an ultra-high molecular weight polyethylene (UHMW-PE) or polytetrafluorethylene (PTFE), preferably an ultra-high molecular weight polyethylene (UHMW-PE).

The ultra-high molecular weight polyethylene (UHMW-PE) in particular is distinguished by very good wear and abrasion resistances even in the face of abrasive media. In-house investigations have shown that by using a first layer which consists at least partially of UHMW-PE in the composite component of the invention, the wear and abrasion resistance of the composite component, particularly of rotor blades, can be significantly improved.

A high molecular weight polyethylene (HMW-PE) in the context of the present invention means a high-molecular polyethylene having an average molar mass of 500 to 1000 kg/mol. An ultra-high molecular weight polyethylene (UHMW-PE) in the context of the present invention means a ultrahigh-molecular polyethylene having an average molar mass of more than 1000 kg/mol. In the context of the present invention it is preferred if the UHMW-PE used has an average molar mass between 1000 kg/mol to 10000 kg/mol, more preferably an average molar mass of between 1000 kg/mol and 5000 kg/mol, especially preferably between 3000 kg/mol and 5000 kg/mol. The average molar mass is determined arithmetically using a Margolies equation. The polyethylene used may be a linear or a crosslinked polyethylene.

The ultrahigh-molecular polyethylene used preferably has a density of 0.93 to 0.94 g/cm³.

In one preferred embodiment of the present invention, the first layer additionally comprises a UV stabilizer, which protects the polyethylene against aging caused by ultraviolet light. Preferred UV stabilizers are organic and inorganic UV absorbers, selected more particularly from the list encompassing benzophenones, benzotriazoles, oxalanilides, phenyltriazines, carbon black, titanium dioxide, iron oxide pigments, and zinc oxide, or 2,2,6,6-tetramethylpiperidine derivatives such as bis(2,2,6,6-tetramethyl-4-piperidyl) sebacate (hindered amine light stabilizers (HALS)).

The long-term resistance toward UV light can be enhanced through the presence of the UV stabilizer.

It is particularly preferred if the first layer consisting at least partially of polyethylene consists predominantly of polyethylene, more particularly consisting of polyethylene to an extent of more than 50 wt %, preferably more than 80 wt %, more preferably more than 95 wt %, consisting more particularly of ultra-high molecular weight polyethylene (UHMW PE), based on the total weight of the layer.

Preference is given to a composite component wherein the elastomer is an ethylene-propylene rubber (EPM), ethylene-propylene-diene rubber (EPDM), ethylene-acrylate rubber (EAM), fluorocarbon rubber (FKM), acrylate rubber (ACM), polyurethane elastomer (preferably thermoplastic polyurethane elastomer), ethylene-vinyl acetate (EVA) or acrylonitrile butadiene rubber (NBR), preferably an ethylene-propylene-diene rubber (EPDM).

It is particularly preferred if the second layer consisting at least partially of an elastomer consists predominantly of elastomer, more particularly consisting of an elastomer to an extent of more than 50 wt %, preferably more than 80 wt %, more preferably more than 95 wt %, consisting more particularly of ethylene-propylene-diene rubber, based on the total weight of the layer.

In one embodiment of the present invention, the second layer consists of two zones of the elastomer. In-house investigations have shown that the production of a composite component is particularly advantageous if first of all a first zone of the elastomer is applied to the first layer. Subsequently, in a second step, a second zone of the elastomer is applied to the first zone of the elastomer. Both zones of the elastomer form the second layer. It has proven here to be advantageous and hence preferred if the textile fabric is embedded only in the second zone of the second layer.

In one preferred embodiment of the present invention, the second layer additionally comprises at least one additive selected from the group consisting of acrylates, methacrylates, epoxy resins, phenolic resins, novolacs, hexamethylenetetramine, hexamethoxymethylmelamine, and guanidines. These additives are suitable for improving the strength of the second layer and/or for improving the adhesion of the second layer to the other layers.

Polymers referred to as elastomer in the context of the present invention are elastically deformable but retain their shape, with a glass transition point located below the service temperature (e.g., 25° C.). Under tensile and pressure loads, the plastics are able to deform elastically, but revert thereafter to their original, undeformed shape.

Preference is given to a composite component wherein the thermoset or the thermoplastic is a polymeric resin system based on epoxide, based on polyurethane, based on methyl methacrylate, based on (meth)acrylate or based on (meth)acrylamide.

It is particularly preferred if the third layer consisting at least partially of a thermoset or a thermoplastic consists predominantly of a thermoset or a thermoplastic, consisting more particularly to an extent of more than 50 wt %, preferably more than 80 wt %, more preferably more than 95 wt % of a thermoset or a thermoplastic.

In the context of this invention, a thermoplastic is a plastic which after it has cured can no longer be deformed by heating without the plastic being destroyed.

In the context of this invention, a thermoplastic is a plastic which within a certain temperature range can be (thermo-plastically) reversibly deformed, the deforming of the plastic, by heating until the liquid melt state is reached, and cooling, being repeated as often as desired.

According to one preferred embodiment of the present invention, the third layer is a fiber-reinforced thermoset or thermoplastic, the fibers being preferably UHMW-PE fibers (e.g., Dyneema fibers), carbon fibers, aramid fibers or glass fibers. The fibers in question are not the rovings but rather fibers which are only present in the third layer.

Fiber-reinforced thermosets or thermoplastics are notable for high mechanical and thermal stability for a low specific weight, and are therefore very suitable for constructing the basis of a rotor blade or rotor blade element.

Preferred in accordance with the invention is a composite component wherein the third layer additionally comprises at least one additive selected from the group consisting of acrylates, methacrylates, phenolic resins, and novolacs.

Likewise preferred is a composite component wherein the thermoset comprises a polymeric resin system with an epoxy resin matrix which prior to curing takes the form of a multicomponent system and includes at least one component comprising an amine curing agent and additionally at least one additive selected from the list consisting of hexamethylenetetramine, hexamethoxymethylmelamine, and guanidines.

Preference is given to a composite component wherein the composite component is a rotor blade, preferably a rotor blade of a wind turbine.

In one embodiment preferred in accordance with the invention, the composite component is a rotor blade having a pressure side, a suction side, a rear edge, and a frontal edge (also called leading rotor blade edge), where the frontal edge extends along the longitudinal direction of the rotor blade between a tip and a root of the rotor blade. It is preferred here if the frontal edge of the rotor blade has the first, second, and third layers and the pressure side, suction side and/or rear edge of the rotor blade preferably do not, or not completely, have the first and second layers.

In one particularly preferred embodiment, the composite component is a rotor blade where the first, second, and third layers are arranged in a region located on the frontal edge and the region has a width orthogonally to the longitudinal axis of the rotor blade of 5 to 35 cm, preferably 10 to 20 cm, more preferably 14 to 18 cm and a length along the longitudinal axis of the rotor blade that corresponds to at least 10%, preferably at least 15%, more preferably at least 20% of the total length of the rotor blade, and/or a length along the longitudinal axis of the rotor blade that corresponds to at most 35%, preferably at most 30%, more preferably at most 25% of the total length of the rotor blade.

It is preferred, furthermore, that the first layer and/or the second layer independently of one another have a thickness of 100 to 5000 μm, preferably a thickness of 300 to 900 μm, more preferably a thickness of 400 to 600 μm.

In-house investigations have shown that with these layer thicknesses there is a very good balance struck between wear and abrasion resistances and the weight of the composite component. If the first layer is too thick, the weight of the composite component is increased without substantial improvement in the wear and abrasion resistances. If the first layer is too thin, however, the wear and abrasion resistances decrease.

Preferred in accordance with the invention is a composite component including the following layer construction:
a) a first layer consisting at least partially of an ultra-high molecular weight polyethylene (UHMW-PE);
b) a second layer consisting at least partially of an ethylene-propylene-diene rubber (EPDM); and
c) a third layer consisting at least partially of a thermoset or a thermoplastic, the thermoset being an epoxide-based polymeric resin system, where a textile fabric with rovings is arranged between the second layer and the third layer such that
   some of the rovings are embedded at least in places completely in the second layer;
   some of the rovings are embedded at least in places completely in the third layer; and
   some of the rovings are embedded at least in places partially in the second layer and partially in the layer, where:
      the textile fabric is a woven or laid-scrim fabric;
      the rovings are rovings made of glass fibers;
      the glass fibers preferably have a ISO 1144 Tex value of between 250 and 2500 tex; and
      the first layer and/or the second layer independently of one another preferably have a thickness of 100 to 5000 μm, more preferably a thickness of 300 to 900 μm, very preferably a thickness of 400 to 600 μm.

Preferred in accordance with the invention is a composite component including the following layer construction:
a) a first layer consisting to an extent of more than 50 wt %, preferably more than 80 wt %, more preferably more than 95 wt % of an ultra-high molecular weight polyethylene (UHMW-PE);
b) a second layer consisting to an extent of more than 50 wt %, preferably more than 80 wt %, more preferably more than 95 wt % of an ethylene-propylene-diene rubber (EPDM); and
c) a third layer consisting to an extent of more than 50 wt %, preferably more than 80 wt %, more preferably more than 95 wt % of a thermoset or a thermoplastic, the thermoset being an epoxide-based polymeric resin system, where a textile fabric with rovings is arranged between the second layer and the third layer such that
   some of the rovings are embedded at least in places completely in the second layer;
   some of the rovings are embedded at least in places completely in the third layer; and
   some of the rovings are embedded at least in places partially in the second layer and partially in the third layer, where
      the textile fabric is a woven or laid-scrim fabric;
      the rovings are rovings made of glass fibers;
      the glass fibers preferably have a ISO 1144 Tex value of between 250 and 2500 tex; and
      the first layer and/or second layer independently of one another preferably have a thickness of 100 to 5000 μm, more preferably a thickness of 300 to 900 μm, very preferably a thickness of 400 to 600 μm.

Preferred in accordance with the invention is a composite component including the following layer construction:
a) a first layer consisting at least partially of an ultra-high molecular weight polyethylene (UHMW-PE);
b) a second layer consisting at least partially of an ethylene-propylene-diene rubber (EPDM); and
c) a third layer consisting at least partially of a thermoset or a thermoplastic, the thermoset being an epoxide-based polymeric resin system, where a textile fabric with rovings is arranged between the second layer and the third layer such that
   some of the rovings are embedded at least in places completely in the second layer;
   some of the rovings are embedded at least in places completely in the third layer; and
   some of the rovings are embedded at least in places partially in the second layer and partially in the third layer, where
      the textile fabric is a woven or laid-scrim fabric;
      the rovings are rovings made of glass fibers;
      the glass fibers preferably have a ISO 1144 Tex value of greater than or equal to 250 tex; and
      the first layer and/or second layer independently of one another preferably have a thickness of 100 to 5000 μm, more preferably a thickness of 300 to 900 μm, very preferably a thickness of 400 to 600 μm.

A further aspect of the present invention relates to a wind turbine comprising a composite component of the invention. It is particularly preferred in this case for the wind turbine to be that of a wind power installation and for the composite component to be arranged on at least one rotor blade element, more particularly on at least one rotor blade edge, preferably a frontal rotor blade edge. It is particularly preferred for the composite component to be arranged on all rotor blade edges, preferably on all frontal rotor blade edges, of a wind power installation.

A further aspect in connection with the present invention relates to a use of the composite component in wind turbines, rotor blades of wind turbines, propellers of airplanes or helicopters, airfoils of airplanes or helicopters, rotor blades of airplanes or helicopters, turbine vanes of propulsion units, bodywork components of vehicles, hull or keel area of watercraft, or contact areas of sports equipment. Particularly preferred is the use in accordance with the invention in rotor blade edges, preferably on leading rotor blade edges, of a wind power installation.

The composite component can also be employed, however, in other areas in which erosion of the surfaces is to be avoided. These are in accordance with the invention, for example:
propellers, airfoils, rotor blades of airplanes or helicopters;
turbine vanes of propulsion units;
bodywork components of vehicles;
hull or keel area of watercraft; or
contact areas of sports equipment.

A further aspect in connection with the present invention relates to a method for producing a composite component, comprising the following steps:
producing or providing a first layer consisting at least partially of polyethylene;
producing or providing a reaction mixture for producing an elastomer;
coating one side of the produced or provided first layer with the produced or provided reaction mixture for producing an elastomer;
producing or providing a textile fabric and laying a textile fabric onto the coated reaction mixture for producing an elastomer, so that some of the rovings are embedded at least in places completely in the reaction mixture;
vulcanizing the produced or provided reaction mixture or allowing it to vulcanize, to give a second layer consisting at least partially of an elastomer;
producing or providing a reaction mixture for producing a thermoset or thermoplastic;
coating the produced second layer with the produced or provided reaction mixture for producing a thermoset or thermoplastic, so that some of the rovings are embedded at least in places completely in the reaction mixture for producing a thermoset or thermoplastic; and
curing the produced or provided reaction mixture for producing a thermoset or thermoplastic, or allowing it to cure, to give a third layer consisting at least partially of a thermoset or thermoplastic.

A further aspect in connection with the present invention relates to a method for producing a composite component, comprising the following steps:
producing or providing a first layer consisting at least partially of polyethylene;
producing or providing a reaction mixture for producing an elastomer;
coating one side of the produced or provided first layer with the produced or provided reaction mixture for producing an elastomer;
vulcanizing the produced or provided reaction mixture or allowing it to vulcanize, to give a first zone of a second layer;
producing or providing a reaction mixture for producing an elastomer;
coating the first zone of the second layer with the produced or provided reaction mixture for producing an elastomer;
producing or providing a textile fabric and laying the textile fabric onto the coated reaction mixture for producing an elastomer, so that some of the rovings are embedded at least in places completely in the reaction mixture;
vulcanizing the produced or provided reaction mixture or allowing it to vulcanize, to give a second zone of the second layer, which completely forms the second layer;
producing or providing a reaction mixture for producing a thermoset or thermoplastic;
coating the produced second layer with the produced or provided reaction mixture for producing a thermoset or thermoplastic, so that some of the rovings are embedded at least in places completely in the reaction mixture for producing a thermoset or thermoplastic; and
curing the produced or provided reaction mixture for producing a thermoset or thermoplastic, or allowing it to cure, to give a third layer consisting at least partially of a thermoset or thermoplastic.

A further aspect in connection with the present invention relates to a composite component produced by a method of the invention.

### BRIEF DESCRIPTION OF THE SEVERAL VIEWS OF THE DRAWINGS

In the context of the present invention, it is preferred for two or more of the aspects denoted above as being preferred to be realized at the same time; especially preferred are the combinations of such aspects and of the corresponding features that are evident from the appended claims.

FIG. 1 shows a diagrammatic representation of a wind power installation with rotor blade element in accordance with the invention;

FIG. 2 shows diagrammatically one embodiment of a rotor blade element in accordance with the invention; and

FIG. 3 shows in diagrammatic representation a detail of the rotor blade element from FIG. 2.

### DETAILED DESCRIPTION

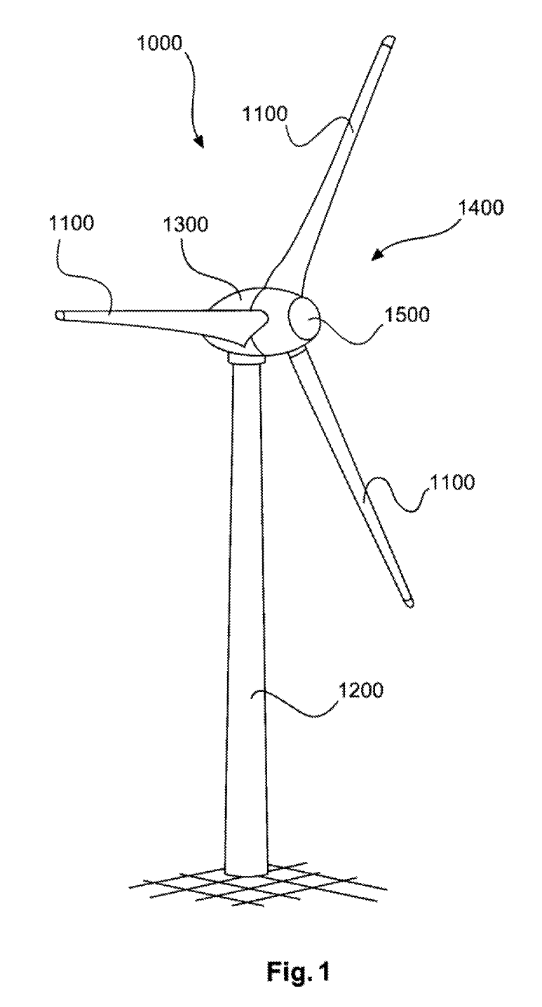

FIG. 1 shows a wind power installation 1000 having a tower 1200 and a nacelle 1300. Arranged on the nacelle 1300 is a rotor 1400 having three rotor blades 1100 and a spinner 1500. In operation, the rotor 1400 is set into rotational motion by the wind and thereby drives a generator in the nacelle 1300. The rotor blades 1100 of the wind power installation 1000 possess a basis (layer 13) comprising a thermoset which is coated in places with a surface foil (layer 11) of polyethylene; an elastomer layer (layer 12) is located between the surface foil and the basis. This construction is elucidated in more detail with reference to the subsequent figures.

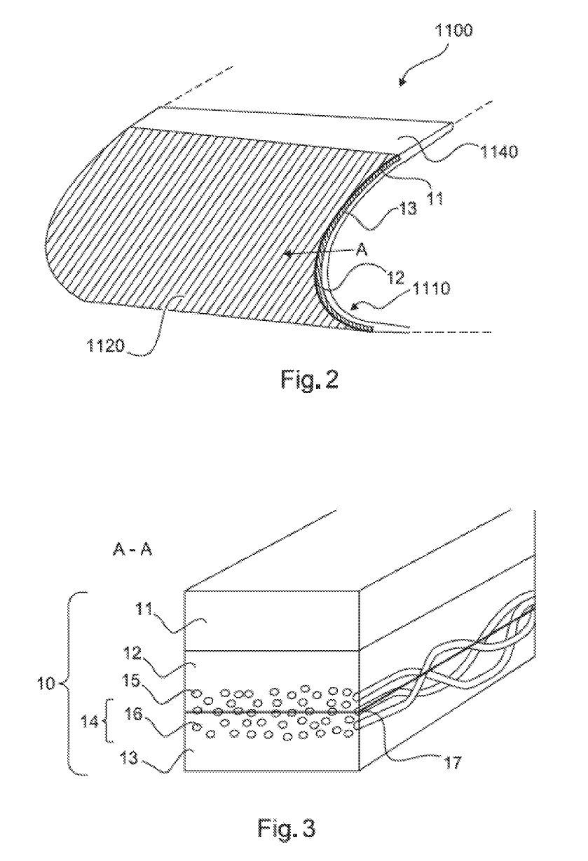

FIG. 2 shows a rotor blade element 1110 of the rotor blade 1100, specifically the leading rotor blade edge. The leading rotor blade edge 1110 possesses a surface foil 11. This foil consists, in this working example, of ultrahigh molecular weight polyethylene (UHMW-PE). The surface foil 11 (layer 11) is joined via an attachment layer 12 (layer 12) to the basis of the rotor blade element 13 (layer 13). The basis 13 (layer 13) of the rotor blade element consists here at least partially of a thermoset. In the working example, the thermoset is an epoxy resin. The attachment layer 12 (layer 12) consists at least partially of an elastomer. As a result of the attachment of the surface foil 11 (layer 11) to the basis 13 (layer 13) by means of an elastomer, it is possible to join UHMW-PE to epoxy resin. The UHMW-PE surface foil 11 (layer 11) is particularly resistant to abrasive loads of the kind occurring during operation of wind power installations, especially at the rotor edges.

FIG. 3 shows a detail of the rotor blade element 1110. At this place on the rotor blade element 1110, the rotor blade element 1110 possesses the following layer construction: A first layer 11 consisting at least partially of polyethylene, a layer 12 consisting partially of an elastomer, and at least one layer 13 as basis, consisting at least partially of a thermoset. A textile fabric 14 with rovings 15, 16, 17 is arranged between the layer 12 and 13 such that some of the rovings 15 are embedded at least in places completely in the layer 12, some of the rovings 16 are embedded at least in places completely in the layer 13, and some of the rovings 17 are embedded at least in places partially in the layer 12 and partially in the layer 13. In this working example, the rovings consist of glass fibers, the thermoset is an epoxy resin, the polyethylene is an ultrahigh molecular weight polyethylene (UHMW-PE), and the elastomer is EPDM.

1. A composite component, comprising:
a) a first layer at least partially made of polyethylene;
b) a second layer at least partially made of an elastomer; and
c) a third layer at least partially made of a thermoset or a thermoplastic,
wherein the first layer is arranged directly on the second layer and wherein the second layer is arranged directly on the third layer, and
wherein a textile fabric with a plurality of rovings is arranged between the second and the third layer wherein;
first portions of the plurality of rovings are embedded completely in the second layer;
second portions of the plurality of rovings are embedded completely in the third layer; and
third portions of the plurality of rovings are embedded partially in the second layer and partially in the third layer.

2. The composite component as claimed in claim 1, wherein the ISO 1144 Tex value of the individual filaments of the rovings is between 250 and 2500 tex.

3. The composite component as claimed in claim 1, wherein the ISO 1144 Tex value of the individual filaments of the rovings has a value of greater than or equal to 250 tex.

4. The composite component as claimed in claim 1, wherein the first portions of the plurality of rovings, which are embedded completely in the second layer, are interspersed predominantly with the elastomer from the second layer at the places at which the plurality of rovings are embedded in the second layer.

5. The composite component as claimed in claim 1, wherein the second portions of the plurality of rovings, which are embedded completely in the third layer, are interspersed predominantly with the thermoset from the third layer at the places at which the plurality of rovings are embedded in the third layer.

6. The composite component as claimed in claim 1, wherein the third portions of the plurality of rovings, which are embedded partially in the second layer and partially in the third layer, are interspersed predominantly with the elastomer from the second layer or with the thermoset from the third layer at the places at which the plurality of rovings are embedded partially in the second layer and partially in the third layer.

7. The composite component as claimed in claim 1, wherein at least one layer, chose among the first layer and the second layer, has a thickness of 100 to 5000 μm.

8. The composite component as claimed in claim 1, wherein the textile fabric is a woven, laid-scrim, knitted or braided fabric.

9. The composite component as claimed in claim 1, wherein the polyethylene is a high molecular weight polyethylene (HMW-PE), an ultra-high molecular weight polyethylene (UHMW-PE) or polytetrafluorethylene (PTFE).

10. The composite component as claimed in claim 1, wherein the elastomer is an ethylene-propylene rubber (EPM), ethylene-propylene-diene rubber (EPDM), ethylene-acrylate rubber (EAM), fluorocarbon rubber (FKM), acrylate rubber (ACM), polyurethane elastomer, ethylene-vinyl acetate (EVA) or acrylonitrile butadiene rubber (NBR).

11. The composite component as claimed in claim 1, wherein the plurality of rovings are made of UHMW-PE fibers, carbon fibers, glass fibers, aramid fibers or mixtures thereof.

12. The composite component as claimed in claim 1, wherein the thermoset or the thermoplastic is a polymeric resin system based on epoxide, polyurethane, methyl methacrylate, (meth)acrylate or (meth)acrylamide.

13. The composite component as claimed in claim 1, wherein:
the textile fabric is a woven or laid-scrim fabric,
the plurality of rovings made of glass fibers,
the polyethylene is an ultra-high molecular polyethylene (UHMW-PE),
the elastomer is an ethylene-propylene-diene rubber (EPDM), and
the thermoset is a polymeric resin system based on epoxide.

14. The composite component as claimed in claim 1, wherein the composite component is a rotor blade.

15. A wind turbine comprising a composite component as claimed in claim 1.

16. A method for producing a composite component comprising:
providing a first reaction mixture configured to produce an elastomer;
coating a surface of a first layer at least partially made of polyethylene with the provided first reaction mixture;
placing a textile fabric onto the coated reaction mixture so that some portions of the rovings are embedded completely in the first reaction mixture;
vulcanizing the first reaction mixture to form a second layer comprising at least partially an elastomer;
providing a second reaction mixture configured to produce a thermoset or thermoplastic;
coating the second layer with the second reaction mixture so that some portions of the rovings are embedded completely in the second reaction mixture; and
curing the second reaction mixture to form a third layer comprising consisting at least partially a thermoset or thermoplastic.

17. The method as claimed in claim 16, wherein the composite component is used to form a portion of a rotor blade.

18. The composite component as claimed in claim 7 wherein both the first layer and the second layer have thicknesses between 300 to 900 μm.

19. The composite component as claimed in claim 15, wherein the composite component is at least a portion of a rotor blade of the wind turbine.
